(19) United States
(12) Patent Application Publication
(10) Pub. No.: US 2005/0080176 A1
(43) Pub. Date: Apr. 14, 2005

(54) Crosslinked polymer gels for filter cake formation

(76) Inventor: Ian D. Robb, Duncan, OK (US)

Correspondence Address: Robert A. Kent;Halliburton Energy Services, 2600 S. 2nd Street, Duncan, OK, 73536, US

(21) Appl. No.: 10/681,863

(22) Filed: Oct. 8, 2003

(51) Int. Cl. C08L 1/00

(52) U.S. Cl. 524/424; 524/493; 524/445; 524/556

(57) ABSTRACT

This invention relates to methods of preparing crosslinked polymer gels useful in subterranean well operations, to compositions comprising such polymers, and to the use of such compositions in treating subterranean formations. In certain exemplary embodiments, the crosslinked polymer gels are produced from emulsion polymerization reactions.

### BACKGROUND OF THE INVENTION

This invention relates to methods of preparing crosslinked polymer gels useful in subterranean well operations, to compositions comprising such polymers, and to the use of such compositions in treating subterranean formations.

During drilling of, inter alia, oil wells, aqueous fluids are injected through a drill pipe into a subterranean formation, then returned to the surface through the annular area between the well bore wall and the drill string. These drilling fluids may, inter alia, lubricate the drill bit, transport cuttings to the surface, overbalance formation pressure to prevent influx into the well, maintain hose stability, suspend solids when the fluid is not circulated, and control fluid loss into the formation. After drilling is complete, a completion fluid may be used. Completion operations may include operations such as cementing the well casing, perforating the well, and setting the tubing, among other things. Completion fluids may be used, inter alia, to control the well pressure, control fluid loss, prevent the collapse of tubing from overpressure, and reduce corrosion of the casing. Completion fluids should be temperature stable, non-settling, non-corrosive and non-damaging to the formation.

Stimulation operations may be conducted on wells in hydrocarbon-bearing subterranean formations, inter alia, to improve the flow of hydrocarbons to the well bore. An example of such a stimulation operation is a fracturing operation, which generally comprises injecting a fracturing fluid through the well bore into a subterranean formation so as to create or enhance at least one fracture therein, thereby producing or augmenting conductive channels through the formation. The fracturing fluid may introduce a particle proppant into these channels, to assist in maintaining such channels within the formation. As the fracturing fluid travels through the formation, propagating at least one fracture therein, the potential arises for fluid to be lost from the propagating fracture or fractures to other regions of the formation where the fluid is not intended to flow. It is particularly desirable to prevent fluid loss, not only during fracturing operations, but also during drilling and cementing operations, in order to, inter alia, mitigate the potential for damage to the formation that may be caused by ingress into the formation of fine particulate matter.

One way of controlling fluid loss is to form a “filter cake” within the formation. Generally, this filter cake is removed before production of hydrocarbons from the formation. One method of forming a filter cake comprises including within a treatment fluid a polymer gel combined with ground salt, calcium carbonate, or other suitable solids. A polymer gel is a material that has an elastic modulus, G′, that is greater than the loss modulus G″ over all frequencies, e.g., a material having elastic properties that predominate over its viscous (or lost energy) properties. Typically, these gels are prepared from natural polymers, such as polysaccharides, including crosslinked polysaccharides. Alternatively, the fluid may be prepared by adding a polymer and a crosslinking agent that will subsequently crosslink the polymer when desired, as opposed to addition of the crosslinked polymer. However, the formation of filter cakes using polymer gels formed from natural polysaccharides is problematic, because such polymer gels commonly contain gel particles having a size greater than 100 microns. This is undesirable, particularly in fracturing operations, because gel particles of size exceeding 100 microns can block the interstitial spaces between proppant sand particles within the fractures, thereby retarding the return flow of desirable hydrocarbons following the completion of a fracture stimulation operation.

### SUMMARY OF THE INVENTION

This invention relates to methods of preparing crosslinked polymer gels useful in subterranean well operations, to compositions containing such polymers, and to the use of such compositions in treating subterranean formations.

An example of a method of the present invention is a method for preparing an aqueous fluid for use in a subterranean formation, comprising the steps of: combining one or more monomers with a cross-linking agent and an initiator; polymerizing the monomers in the presence of the cross-linking agent to form synthetic, crosslinked polymer gels that have an average particle size less than about 100 microns; and combining the synthetic, crosslinked polymer gels with water to form an aqueous fluid.

Another example of a method of the present invention is a method for treating a subterranean formation penetrated by a well bore comprising the step of: contacting a subterranean formation with an aqueous treating fluid comprising a synthetic, crosslinked polymer gel so as to form a filter cake therein, wherein the synthetic, crosslinked polymer gel has an average particle size less than about 100 microns.

An example of a composition of the present invention is an aqueous fluid useful in subterranean well operations, comprising synthetic, crosslinked polymer gels having an average particle size less than about 100 microns.

The features, and advantages of the present invention will be readily apparent to those skilled in the art upon a reading of the description of the preferred embodiments that follows.

### DESCRIPTION OF EXEMPLARY EMBODIMENTS

This invention relates to methods of preparing crosslinked polymer gels useful in subterranean well operations, to compositions containing such crosslinked polymer gels, and to the use of such compositions in treating subterranean formations. In certain exemplary embodiments of the present invention, the crosslinked polymer gel may be included in an improved fracturing fluid to prevent fluid loss to the formation during fracturing operations. In such exemplary embodiments, the crosslinked polymer gels have a particle size that is large enough to obstruct pore throats in the surface of the subterranean formation, thereby preventing or mitigating fluid loss to the formation from the fracturing fluid, as the fracturing fluid travels through the formation, creating or enhancing at least one fracture therein. In such exemplary embodiments, the particle size of the crosslinked polymer gels is also small enough that, upon completion of the fracturing operation, they may flow back towards the well bore through the interstitial spaces present among proppant deposited within the fractures during the operation.

In one embodiment, the crosslinked polymer gels are prepared by combining, in a suitable reaction vessel, a monomer, a crosslinking agent, and an initiator. To achieve the beneficial effects of the present invention, the particle size of the crosslinked polymer gel that is produced must be limited, otherwise the crosslinking reaction may generate a crosslinked polymer gel in the shape of the reaction vessel, which crosslinked polymer gel would have to be mechanically cut before it may be pumped into a subterranean formation. By conducting the reaction so that the resulting crosslinked polymer gel has an average particle size ranging from about 0.1 micron to about 10 microns, the crosslinked polymer gel may be useful for treating operations without any further mechanical processing.

A wide variety of monomers may be suitable for use in the present invention. Generally, the monomers used in the methods of the present invention comprise any synthetic monomers capable of polymerizing. Examples of suitable monomers include molecules having a polymerizable functionality (such as vinyl or epoxide groups), and an acid- or base-ionizable functionality such as a carboxylate, sulfonate, sulfate, phosphate group or amine. Examples of monomers useful in the present invention include, but are not limited to, epoxides (e.g., ethylene oxide, propylene oxide), methacrylic acid, acrylic acid, butyl acrylate, ethyl acrylate, methyl methacrylate, dimethyl ethyl amino methacrylate, acrylamide, and 2-acrylamide-2-methyl-1-propanesulfonic acid. The preceding list is not intended to be an exhaustive list, but rather is intended merely to provide an illustration of some types of materials that may be suitable for use in accordance with the present invention. Other materials may also be suitable, and one of ordinary skill in the art with the benefit of this disclosure will be able to identify an appropriate monomer for a particular application.

In certain exemplary embodiments, the monomers used in the present invention may be reacted in an oil-in-water emulsion polymerization or a water-in-oil emulsion polymerization to yield a synthetic crosslinked polymer gel having an alkali swellable latex, e.g., the crosslinked polymer gel can absorb water and swell when brought into contact with an alkaline aqueous solution, then shrink in size when contacted by an acidic solution. In such exemplary embodiments, such acid-induced shrinkage may improve the ability of the crosslinked polymer gels to flow towards the well bore upon the completion of a treatment operation. It is further believed that the exemplary crosslinked polymer gels having an alkali swellable latex may swell up to about 10 times their original diameter (e.g, up to about 1,000 times their original volume).

The monomers used in the present invention may, in certain exemplary embodiments, include monomers of weak acids and/or weak bases. An exemplary embodiment of a monomer of a weak base is dimethyl ethyl amino methacrylate. An exemplary embodiment of a monomer of a weak acid is acrylic acid. In certain exemplary embodiments of the present invention where the monomers comprise mixtures of weak acids and weak bases, the particle size of the crosslinked polymer gels produced may be varied by altering solution conditions (e.g., ionic strength, or pH, for example). For instance, a treatment fluid comprising such crosslinked polymer gels may be placed at the surface of a subterranean formation at an alkaline pH (e.g., a pH in the range of from about 8 to about 12 or more). Then, after a desired period of time has passed, the subterranean pH may be decreased to a pH of about 7, due to the buffering action of the surface of the subterranean formation, thereby causing the particle size of the crosslinked polymer gels to decrease, thereby facilitating their removal from the subterranean surface by flowing upwards through the well bore. Generally, the extent to which the particle size of the crosslinked polymer gels may vary with pH will be controlled by factors such as, inter alia, the crosslink density. Generally, the particle size of the crosslinked polymer gels of the present invention will increase as pH increases. However, certain exemplary embodiments of the crosslinked polymer gels of the present invention comprising a polybase (e.g., poly(dimethyl ethyl amino methacrylate), and the like) may decrease in particle size as pH increases.

A wide variety of crosslinking agents may be used with in accordance with the present invention. Generally, the crosslinking agents used in the present invention comprise organic molecules having two or more vinyl groups. In certain exemplary embodiments of the present invention, the crosslinking agent is N,N-methylenebisacrylamide. In certain other exemplary embodiments, the crosslinking agent is divinylbenzene. One of ordinary skill in the art, with the benefit of this disclosure, will be able to select crosslinking agents suitable for carrying out this invention.

The initiator used in the present invention may be chosen from among a broad variety of compounds. In certain exemplary embodiments of the present invention that involve the polymerization of carbon/carbon double and triple bonds, suitable initiators may include free radical initiators, such as persulfate salts (e.g., ammonium persulfate, sodium persulfate, and the like). Other initiators that may be used in this invention include, but are not limited to, azo compounds, percarbonates, and metal catalyzed peroxide systems. In certain other exemplary embodiments of the present invention, initiation may be triggered by heat or radiation of a suitable wavelength, e.g., UV light. One of ordinary skill in the art, with the benefit of this disclosure, will be able to select an appropriate initiator for a particular application.

Generally, the crosslinked polymer gels of the present invention may be produced from either an oil-in-water emulsion polymerization, or a water-in-oil emulsion polymerization. One of ordinary skill in the art, with the benefit of this disclosure, will understand how to prepare emulsions suitable for those embodiments. One example comprises a 50/50 mixture of a paraffin and xylene or toluene combined with up to about 60-70% water by weight, in the presence of a suitable surfactant, such as “AEROSOL OT,” or a commercial polymeric surfactant, such as “HYPERMER B246 SF,” commercially available from Uniqema. The resulting crosslinked polymer gels will have a particle size in the range of less than about 1 mm. In certain exemplary embodiments, the resulting crosslinked polymer gels will have a particle size in the range of from about 1 micron to about 10 microns. In certain exemplary embodiments of the present invention where the polymerization is conducted as a water-in-oil emulsion, the particle size of the crosslinked polymer gels may be largely determined by the size of the water drops. The size of the water drops is controlled by the amount of surfactant and the extent of shearing that is conducted. Generally, the particle size of the crosslinked polymer gels produced from water-in-oil emulsion polymerizations is in the range of from about 1 to about 10 microns. In certain exemplary embodiments of the present invention where the polymerization is conducted as an oil-in-water emulsion, the size of the latexes formed will be controlled by the amount of surfactant, monomer, and initiator used in the formulation of the emulsion. Generally, the particle size of the crosslinked polymer gels produced from oil-in-water emulsion polymerizations is in the range of from about 0.1 to about 10 microns.

During crosslinking, it may be desirable to heat the reaction vessel to begin the reaction. In the case of free-radical initiated polymerization of vinyl or acetylinic carbon, the reaction is exothermic once started. In certain exemplary embodiments involving those reactions, the vessel is generally maintained at a temperature of about 50-60° C. One of ordinary skill in the art, with the benefit of this disclosure, will be able to determine other reaction conditions. For example, in certain exemplary embodiments it may be desirable to agitate the reaction vessel, e.g., by shaking or stirring it. In certain exemplary embodiments it may also be desirable to introduce an inert gas, such as nitrogen, into the reaction mixture or into the vessel headspace.

In certain exemplary embodiments of the present invention, the crosslinked polymer gels may be produced by conducting the polymerization reaction in a solvent in which the monomers, the crosslinking agent and initiator are soluble, but in which the growing crosslinked polymer is insoluble, thereby producing swellable crosslinked polymer gels having a finite particle size. One of ordinary skill in the art, with the benefit of this disclosure, will be able to recognize an appropriate solvent for a particular application.

A treating fluid comprising the crosslinked polymer gel may include other materials suitable for the formation of filter cake in a subterranean formation, including, but not limited to, a variety of optional additives recognizable to one of ordinary skill in the art with the benefit of this disclosure. For example, the treating fluid may comprise, inter alia, gel stabilizers, breakers, clay stabilizers, bactericides, fluid loss additives, surfactants, and weighting agents. The selection and use of such additives is within the ability of persons of ordinary skill familiar with this disclosure. In certain exemplary embodiments of the present invention, the treatment fluid comprising the crosslinked polymer gels of the present invention further comprises solids. Examples of suitable solids include, but are not limited to, granular materials such as calcium carbonate, clays, barite, silica or rock salt may be used, or a mixture thereof. In such exemplary embodiments, the crosslinked polymer gels may block the interstitial spaces between the solids, thereby forming a filter cake on the surface of the subterranean formation. The use of swellable crosslinked polymer gels permits such crosslinked polymer gels to block increasingly large interstitial spaces, thereby permitting an operator to use coarser solids in the treatment fluid formulation.

In certain exemplary embodiments, the treating fluid is introduced into a subterranean formation in the form of a slurry. A filter cake of the suspended materials is formed on the face of the formation so as to control fluid loss. The quantity of gel or granular material to be used in accordance with the embodiments of this invention is that which will achieve a desired level of fluid loss control. That quantity may depend, inter alia, upon the permeability of the formation, the formation temperature, and the desired level of loss control.

An example of a method of the present invention is a method for preparing an aqueous fluid for use in a subterranean formation, comprising the steps of: combining one or more monomers with a cross-linking agent and an initiator; polymerizing the monomers in the presence of the cross-linking agent to form synthetic, crosslinked polymer gels that have an average particle size less than about 100 microns; and combining the synthetic, crosslinked polymer gels with water to form an aqueous fluid.

Another example of a method of the present invention is a method for treating a subterranean formation penetrated by a well bore comprising the step of: contacting a subterranean formation with an aqueous treating fluid comprising a synthetic, crosslinked polymer gel so as to form a filter cake therein, wherein the synthetic, crosslinked polymer gel has an average particle size less than about 100 microns.

An example of a composition of the present invention is an aqueous fluid useful in subterranean well operations, comprising synthetic, crosslinked polymer gels having an average particle size less than about 100 microns.

To facilitate a better understanding of the present invention, the following examples of some of the preferred embodiments are given. In no way should such examples be read to limit the scope of the invention.

### EXAMPLE 1

Crosslinked polymer gels comprising alkali swellable latexes were prepared at a pH of 3, by oil-in-water emulsion polymerization at 60° C., using potassium persulfate as initiator and divinyl benzene as crosslinking agent, along with other components as shown in Table 1. The crosslinked polymer gels had a particle size of about 2 microns. The pH of the solution was elevated to 12 through the addition of sodium hydroxide, thereby swelling the crosslinked polymer gels (as demonstrated by the fact that the latex clarified). About 150 ml of the solution comprising the swollen crosslinked polymer gels was mixed with 6 g of calcium carbonate having a mean size of about 50 microns. This system was filtered through a Whatman No. 5 cellulose filter paper having a pore size of about 2.5 microns under 500 psi pressure for 20 minutes, and the amount of filtrate was measured. The results are shown in Table 1.

TABLE 1

| Compound | Sample A | Sample B | Sample C | Sample D |
|---|---|---|---|---|
| Water | 150 g | 150 g | 150 g | 150 g |
| Methacrylic acid | 4.5 g | 4.5 g | 3.0 g | 3.0 g |
| Butyl acrylate | 0.5 g | 0.5 g | 0.5 g | 0.5 g |
| Divinyl benzene | 0.1 g | 0.0 g | 0.1 g | 0.0 g |
| Sodium dodecyl | 0.1 g | 0.1 g | 0.15 g | 0.15 g |
| benzene | | | | |
| sulfonate | | | | |
| Potassium | 1.8 g | 1.8 g | 1.8 g | 1.8 g |
| persulfate | | | | |
| Filtrate weight | 4.0 g | 150 g | 5.0 g | 24 g |

The above Example demonstrates, inter alia, that the crosslinked polymer gels of the present invention provide reduced fluid loss in combination with inorganic particles than do similar polymers that are not crosslinked.

### EXAMPLE 2

A water-in-oil emulsion was prepared by dissolving HYPERMER B247 SF in a mixture of xylene and NORPAR 12, a dodecane commercially available from ExxonMobil Corporation. A Silverson high shear mixer was used to stir into this mixture a solution of water, monomers, crosslinking agents, and initiators as shown in Table 2 below. The water-in-oil emulsion was maintained at 60° C. for 10 hours to complete the polymerization.

Fluid loss experiments were conducted on the resulting emulsion as follows. First, 200 ml of water comprising 1 gram of sodium hydroxide were added, with stirring, to 200 ml of the emulsion. Fifty milliliters of this diluted emulsion were set apart, and 1 gram of microsand comprising silica particles of about 4 microns were added, with stirring. The resulting mixture was filtered under 200 psi pressure through 2.5 micron Whatman cellulose filter paper. After 4 minutes, the weight of filtrate was recorded.

TABLE 2

| Compound | Sample E | Sample F |
|---|---|---|
| NORPAR 12 | 50 grams | 50 grams |
| Xylene | 50 grams | 50 grams |
| HYPERMER B246SF | 0.6 grams | 0.6 grams |
| Water | 80 grams | 80 grams |
| Acrylic acid | 5.0 grams | 5.0 grams |
| Methylene bisacrylamide (crosslinker) | 0.2 grams | 0.0 grams |
| Sodium chloride | 2.0 grams | 2.0 grams |
| Sodium persulfite (initiator) | 0.6 grams | 0.6 grams |
| Filtrate weight | 0.53 grams | 32.9 grams |

The above Example demonstrates, inter alia, that the crosslinked polymer gels of the present invention provide reduced fluid loss in combination with inorganic particles than do similar polymers that are not crosslinked.

### EXAMPLE 3

Water-in-oil emulsions were prepared as in Example 2, but using materials as shown in Table 3. The resulting emulsions were then centrifuged at 3,000 rpm to separate the water drops containing the polymer. Two grams of the concentrated emulsion were set apart, and 40 grams of water, 0.1 gram of sodium dodecyl sulfate, 0.1 grams of sodium hydroxide and 1.0 grams of calcium carbonate solid having a mean size of about 50 microns were added. This mixture was filtered under 400 psi pressure through a 2.5 micron Whatman cellulose paper. After 1 minute, the weight of filtrate collected was recorded.

TABLE 3

| Compound | Sample G | Sample H |
|---|---|---|
| NORPAR 12 | 50 grams | 50 grams |
| Xylene | 50 grams | 50 grams |
| HYPERMER B246SF | 0.6 grams | 0.6 grams |
| Water | 80 grams | 80 grams |
| Acrylic acid | 4.0 grams | 4.0 grams |
| Dimethyl ethyl amino | 8.0 grams | 8.0 grams |
| methacrylate | | |
| Methylene bisacrylamide | 0.1 grams | 0.0 grams |
| (crosslinker) | | |
| Sodium chloride | 2.0 grams | 2.0 grams |
| Sodium persulfite (initiator) | 0.6 grams | 0.6 grams |
| Filtrate weight | 5.9 grams | 35 grams |

The above Example demonstrates, inter alia, that the crosslinked polymer gels of the present invention provide reduced fluid loss in combination with inorganic particles than do similar polymers that are not crosslinked.

Thus, the present invention is well adapted to carry out the objects and attain the ends and advantages mentioned as well as those that are inherent therein. While numerous changes may be made by those skilled in the art, such changes are encompassed within the spirit and scope of this invention as defined by the appended claims.

1. A method for preparing an aqueous fluid for use in a subterranean formation, comprising:
combining one or more monomers with a cross-linking agent and an initiator;
polymerizing the monomers in the presence of the cross-linking agent to form synthetic, crosslinked polymer gels that have an average particle size less than about 100 microns; and
combining the synthetic, crosslinked polymer gels with water to form an aqueous fluid.

2. The method of claim 1 wherein the aqueous fluid further comprises solids.

3. The method of claim 2 wherein the synthetic, crosslinked polymer gels block the interstitial spaces among the solids so as to form a filter cake in the subterranean formation.

4. The method of claim 3 wherein the solids comprise calcium carbonate, silica, barite, a clay, or mixtures thereof.

5. The method of claim 1 wherein the monomer is a synthetic monomer capable of polymerizing.

6. The method of claim 4 wherein the monomer is a monomer of a weak acid or a weak base.

7. The method of claim 1 wherein the monomer comprises a monomer selected from the group consisting of methacrylic acid, acrylic acid, butyl acrylate, ethyl acrylate, methyl methacrylate, dimethyl ethyl amino methacrylate, acrylamide, or 2-acrylamide-2-methyl-1-propanesulfonic acid, an epoxide, and combinations thereof.

8. The method of claim 1 wherein the monomer comprises methacrylic acid and/or butyl acrylate.

9. The method of claim 1 wherein the initiator comprises a free radical initiator, an azo compound, a percarbonate, a metal-catalyzed peroxide system, or radiation.

10. The method of claim 8 wherein the initiator is a free radical initiator, and wherein the free radical initiator comprises a material selected from the group consisting of: ammonium persulfate, sodium persulfate, potassium persulfate, and combinations thereof.

11. The method of claim 8 wherein the free radical initiator comprises potassium persulfate.

12. The method of claim 1 wherein the crosslinking agent comprises a molecule having two or more vinyl chemical groups.

13. The method of claim 1 wherein the crosslinking agent comprises a material selected from the group consisting of N,N-methylenebisacrylamide and divinyl benzene.

14. The method of claim 1 wherein the crosslinking agent comprises divinyl benzene.

15. The method of claim 1 wherein the step of polymerizing the monomers comprises an emulsion polymerization reaction.

16. The method of claim 15 wherein the reaction is a water-in-oil emulsion polymerization.

17. The method of claim 15 wherein the reaction is an oil-in-water emulsion polymerization.

18. The method of claim 15 wherein the synthetic, crosslinked polymer gels comprise alkali swellable latexes.

19. The method of claim 18 wherein the average particle size of the synthetic, crosslinked polymer gels decreases as the pH of the subterranean formation decreases.

20. The method of claim 19 wherein the synthetic, crosslinked polymer gels have a diameter, and wherein the increase of the average particle size constitutes an increase in the diameter of up to about 10 times the original diameter.

21. The method of claim 1 wherein the synthetic, crosslinked polymer gels have an average particle size in the range of from about 0.1 micron to about 100 micron.

22. The method of claim 1 wherein the synthetic, crosslinked polymer gels have an average particle size in the range of from about 0.1 micron to about 50 micron.

23. The method of claim 1 wherein:
the monomer comprises a monomer selected from the group consisting of methacrylic acid, acrylic acid, butyl acrylate, ethyl acrylate, methyl methacrylate, dimethyl ethyl amino methacrylate, acrylamide, or 2-acrylamide-2-methyl-1-propanesulfonic acid, an epoxide, and combinations thereof;
the crosslinking agent comprises a molecule having two or more vinyl chemical groups; and
the initiator comprises a free radical initiator.

24. The method of claim 23 wherein the crosslinking agent comprises a material selected from the group consisting of N,N-methylenebisacrylamide and divinyl benzene.

25. The method of claim 23 wherein
the monomer comprises methacrylic acid and a material selected from the group consisting of butyl acrylate, a sulfonate, and 2-acrylamide-2-methyl-1-propanesulfonic acid;
the crosslinking agent comprises divinyl benzene; and
the initiator comprises a free radical initiator.

26. The method of claim 25 wherein the free radical initiator comprises potassium persulfate, ammonium persulfate, or sodium persulfate.

27. The method of claim 23 wherein the step of polymerizing is carried out in a water in oil emulsion.

28. The method of claim 23 wherein the step of polymerizing is carried out in an oil in water emulsion.

29. A method for treating a subterranean formation penetrated by a well bore comprising the step of:
contacting a subterranean formation with an aqueous treating fluid comprising a synthetic, crosslinked polymer gel so as to form a filter cake therein, wherein the synthetic, crosslinked polymer gel has an average particle size less than about 100 microns.

30. The method of claim 29 wherein the synthetic, crosslinked polymer gel is produced from a reaction involving one or more monomers, a crosslinking agent, and an initiator.

31. The method of claim 29 wherein the aqueous treating fluid further comprises solids selected from the group consisting of calcium carbonate, silica, barite, clay, and mixtures thereof.

32. The method of claim 30 wherein one monomer is a synthetic monomer capable of polymerizing.

33. The method of claim 32 wherein the monomer is a monomer of a weak acid or a weak base.

34. The method of claim 30 wherein the monomer comprises a monomer selected from the group consisting of methacrylic acid, acrylic acid, butyl acrylate, ethyl acrylate, methyl methacrylate, dimethyl ethyl amino methacrylate, acrylamide, or 2-acrylamide-2-methyl-1-propanesulfonic acid, an epoxide, and combinations thereof.

35. The method of claim 30 wherein the monomer comprises methacrylic acid and butyl acrylate.

36. The method of claim 30 wherein the initiator comprises a free radical initiator, an azo compound, a percarbonate, a metal-catalyzed peroxide system, or radiation.

37. The method of claim 36 wherein the initiator comprises a free radical initiator, and wherein the free radical initiator comprises a material selected from the group consisting of: ammonium persulfate, sodium persulfate, potassium persulfate, and combinations thereof.

38. The method of claim 36 wherein the free radical initiator comprises potassium persulfate.

39. The method of claim 30 wherein the crosslinking agent comprises a molecule having two or more vinyl chemical groups.

40. The method of claim 30 wherein the crosslinking agent comprises a material selected from the group consisting of N,N-methylenebisacrylamide and divinylbenzene.

41. The method of claim 40 wherein the crosslinking agent comprises divinyl benzene.

42. The method of claim 30 wherein the reaction comprises an emulsion polymerization reaction.

43. The method of claim 42 wherein the reaction is a water-in-oil emulsion polymerization.

44. The method of claim 42 wherein the reaction is an oil-in-water emulsion polymerization.

45. The method of claim 42 wherein the synthetic, crosslinked polymer gels comprise alkali swellable latexes.

46. The method of claim 45 wherein the average particle size of the synthetic, crosslinked polymer gels decreases as the pH of the subterranean formation decreases.

47. The method of claim 46 wherein the synthetic, crosslinked polymer gels have a diameter, and wherein the increase of the average particle size constitutes an increase in the diameter of up to about 10 times the original diameter.

48. The method of claim 29 wherein the synthetic, crosslinked polymer gel particles have an average particle size in the range of from about 0.1 micron to about 100 microns.

49. The method of claim 29 wherein the synthetic, crosslinked polymer gel particles have an average particle size in the range of from about 0.1 micron to about 50 microns.

50. The method of claim 30 wherein:
the monomer comprises a monomer selected from the group consisting of methacrylic acid, acrylic acid, butyl acrylate, ethyl acrylate, methyl methacrylate, dimethyl ethyl amino methacrylate, acrylamide, or 2-acrylamide-2-methyl-1-propanesulfonic acid, an epoxide, and combinations thereof;
the crosslinking agent comprises a molecule having two or more vinyl chemical groups; and
the initiator comprises a free radical initiator.

51. The method of claim 50 wherein the crosslinking agent comprises a material selected from the group consisting of N,N-methylenebisacrylamide and divinylbenzene.

52. The method of claim 50 wherein
the monomer comprises methacrylic acid and a material selected from the group consisting of a sulfonate, butyl acrylate, and 2-acrylamide-2-methyl-1-propanesulfonic acid;
the crosslinking agent comprises divinyl benzene; and
the initiator comprises a free radical initiator.

53. The method of claim 52 wherein the free radical initiator comprises potassium persulfate, ammonium persulfate, or sodium persulfate.

54. The method of claim 52 wherein the reaction is carried out in a water in oil emulsion.

55. The method of claim 52 wherein the reaction is carried out in an oil in water emulsion.

56. An aqueous fluid useful in subterranean well operations, comprising synthetic, crosslinked polymer gels having an average particle size less than about 100 microns.

57. The fluid of claim 56 further comprising solids selected from the group consisting of calcium carbonate, silica, barite, and clays.

58. The fluid of claim 57 wherein the synthetic, crosslinked polymer gels are capable of blocking the interstitial spaces among the solids so as to form a filter cake in a subterranean formation.

59. The fluid of claim 56 wherein the synthetic, crosslinked polymer gels have an average particle size in the range of from about 0.1 micron to about 100 microns.

60. The fluid of claim 56 wherein the synthetic, crosslinked polymer gels have an average particle size in the range of from about 0.1 micron to about 50 microns.

61. The fluid of claim 56 wherein the synthetic, crosslinked polymer gels are formed from synthetic monomers capable of polymerizing.

62. The fluid of claim 61 wherein the synthetic, crosslinked polymer gels are formed from a monomer of a weak acid and/or a monomer of a weak base.

63. The fluid of claim 56 wherein the synthetic, crosslinked polymer gel particles are formed from a monomer selected from the group consisting of methacrylic acid, acrylic acid, butyl acrylate, ethyl acrylate, methyl methacrylate, dimethyl ethyl amino methacrylate, acrylamide, or 2-acrylamide-2-methyl-1-propanesulfonic acid, an epoxide, and combinations thereof.

64. The fluid of claim 56 wherein the synthetic, crosslinked polymer gels are formed from crosslinking agents that comprise a molecule having two or more vinyl chemical groups.

65. The fluid of claim 64 wherein the crosslinking agent comprises a material selected from the group consisting of N,N-methylenebisacrylamide and divinylbenzene.

66. The fluid of claim 64 wherein the crosslinking agent comprises divinyl benzene.

67. The fluid of claim 56 wherein the synthetic, crosslinked polymer gels are produced from an emulsion polymerization reaction.

68. The fluid of claim 67 wherein the reaction is a water-in-oil emulsion polymerization.

69. The fluid of claim 67 wherein the reaction is an oil-in-water emulsion polymerization.

70. The fluid of claim 67 wherein the synthetic, crosslinked polymer gels comprise alkali swellable latexes.

71. The fluid of claim 70 wherein the average particle size of the synthetic, crosslinked polymer gels decreases as the pH in a subterranean environment decreases.

72. The fluid of claim 71 wherein the synthetic, crosslinked polymer gels have a diameter, and wherein the increase of the particle size constitutes an increase in the diameter of up to about 10 times the original diameter.

73. The fluid of claim 56 wherein
the synthetic, crosslinked polymer gels are formed from monomers that comprise materials selected from the group consisting of methacrylic acid, acrylic acid, butyl acrylate, ethyl acrylate, methyl methacrylate, dimethyl ethyl amino methacrylate, acrylamide, or 2-acrylamide-2-methyl-1-propanesulfonic acid, an epoxide, and combinations thereof;
the synthetic, crosslinked polymer gels are formed from crosslinking agents that comprise materials selected from the group consisting of N,N-methylenebisacrylamide and divinylbenzene; and
the synthetic, crosslinked polymer gels have an average particle size in the range of from about 0.1 micron to about 100 microns.
